(19) United States
(12) Patent Application Publication
(10) Pub. No.: US 2014/0168372 A1
(43) Pub. Date: Jun. 19, 2014

(54) SENSING APPARATUS AND SENSING METHOD FOR GENERATING THREE-DIMENSIONAL IMAGE INFORMATION

(71) Applicant: EMINENT ELECTRONIC TECHNOLOGY CORP. LTD., Hsinchu (TW)

(72) Inventors: TOM CHANG, Taipei City (TW); Kao-Pin Wu, New Taipei City (TW); Chih-Jen Fang, Tainan City (TW); Shang-Ming Hung, Hsinchu County (TW)

(73) Assignee: EMINENT ELECTRONIC TECHNOLOGY CORP. LTD., Hsinchu (TW)

(21) Appl. No.: 14/106,854

(22) Filed: Dec. 16, 2013

Related U.S. Application Data
(60) Provisional application No. 61/738,374, filed on Dec. 17, 2012.

(30) Foreign Application Priority Data
Nov. 1, 2013 (TW) 102139832

(51) Int. Cl. H04N 13/02; H04N 5/33; G06K 9/00

(52) U.S. Cl. CPC H04N 13/025; G06K 9/00335; H04N 5/33; H04N 5/332
USPC 348/46

(57) ABSTRACT

A sensing apparatus includes an infrared light generating device, an image sensing unit, a processing circuit and a control circuit. The image sensing unit is arranged for detecting a first infrared light signal reflected from an object to generate a first sensing signal when the infrared light generating device is activated, and detecting a second infrared light signal reflected from the object to generate a second sensing signal when the infrared light generating device is deactivated. The processing circuit is coupled to the image sensing unit, and is arranged for generating three-dimensional image information of the object according to at least the first sensing signal and the second sensing signal, wherein the three-dimensional image information includes depth information. The control circuit is arranged for control activation and deactivation of the infrared light generating device, sensing operations of the image sensing unit, and signal processing operations of the processing circuit.

### CROSS REFERENCE TO RELATED APPLICATIONS

This application claims the benefit of U.S. provisional application No. 61/738,374, filed on Dec. 17, 2012, the contents of which are incorporated herein by reference.

### BACKGROUND OF THE INVENTION

1. Field of the Invention

The disclosed embodiments of the present invention relate to a sensing apparatus, and more particularly, to a sensing apparatus using an infrared light sensing mechanism to detect an image so as to generate three-dimensional image information, and a related sensing method.

2. Description of the Prior Art

As a conventional image sensor cannot detect depth variations of a sensed object, an image captured by the conventional image sensor (i.e. a two-dimensional (2D) image) looks flat and unrealistic.

Additionally, a conventional mobile device (e.g. a smart phone, a tablet personal computer (PC) or a notebook PC) is typically equipped with an image sensor and other types of sensors in order to detect an object image or information on the surroundings. For example, a user facing camera including an image sensor is used to capture an image, wherein an ambient light sensor (ALS) and a proximity sensor (PS) (accompanied with an infrared (IR) emitter) are installed near the user facing camera. The ALS is used to adjust screen brightness according to an ambient light level. In addition, the ALS is used to turn on a flash light while the user facing camera is triggered to acquire image(s). The PS accompanied with the IR emitter are used to detect if the mobile device is being held next to the ear (or deposited into the bag). When it is detected that the mobile device is being held next to the ear (or deposited into the bag), the PS causes the mobile device to turn off a backlight source and a touch sensor, thus improving a battery life of the mobile device and mitigating a false triggering of touch sensing. However, different sensors installed in the mobile device need respective circuit modules or integrated circuits (ICs), which increases production costs and a size of the mobile device.

Thus, there is a need for a sensing apparatus which can capture more realistic image information (e.g. three-dimensional (3D) image information) and integrate multiple sensors into a single module or a single IC.

### SUMMARY OF THE INVENTION

It is therefore one objective of the present invention to provide a sensing apparatus using an infrared light sensing mechanism to detect an image so as to generate three-dimensional image information, and a related sensing method to solve the above problems.

It is therefore another objective of the present invention to provide a 3D image sensing apparatus to facilitate integration of an optical-mechanical system and/or integration of an optical-mechanical-electrical system to thereby reduce production costs and improve performance.

According to an embodiment of the present invention, an exemplary sensing apparatus is disclosed. The exemplary sensing apparatus comprises an infrared light generating device, an image sensing unit, a processing circuit and a control circuit. The image sensing unit is arranged for detecting a first infrared light signal reflected from an object to generate a first sensing signal when the infrared light generating device is activated, and detecting a second infrared light signal reflected from the object to generate a second sensing signal when the infrared light generating device is deactivated. The processing circuit is coupled to the image sensing unit, and is arranged for generating three-dimensional image information of the object according to at least the first sensing signal and the second sensing signal, wherein the three-dimensional image information includes depth information. The control circuit is coupled to the infrared light generating device, the image sensing unit and the processing circuit, and is arranged for control activation and deactivation of the infrared light generating device, sensing operations of the image sensing unit, and signal processing operations of the processing circuit.

According to an embodiment of the present invention, an exemplary sensing method is disclosed. The exemplary sensing method comprises the following steps: activating an infrared light generating device to detect a first infrared light signal reflected from an object in order to generate a first sensing signal; deactivating the infrared light generating device to detect a second infrared light signal reflected from the object in order to generate a second sensing signal; and generating three-dimensional image information of the object according to at least a signal difference between the first sensing signal and the second sensing signal, wherein the three-dimensional image information includes depth information.

The proposed sensing apparatus and sensing method may obtain depth information/3D image information of an object, thus providing a more realistic image. Additionally, the proposed sensing apparatus integrates multiple functions, including image sensing, ambient light sensing (including ambient color sensing and ambient color temperature sensing), proximity sensing, IR light emitting and gesture recognition, into a single module/IC to thereby greatly reduce production costs and enhance system performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary image processing system according to an embodiment of the present invention.

FIG. 2 is an implementation of the sensing apparatus shown in FIG. 1.

FIG. 3 is a timing diagram of control signals of the infrared light generating device and the image sensing unit shown in FIG. 2.

FIG. 4 is an implementation of the image sensing unit, the visible light detection unit, the dark sensing unit and the infrared light detection unit shown in FIG. 2.

FIG. 5 is a cross-section view of sensing devices included in the image sensing unit shown in FIG. 4.

FIG. 6 is a diagram illustrating a relationship between a wavelength of incident light and a light transmittance of each filter shown in FIG. 5.

FIG. 7 is a cross-section view of another implementation of sensing devices included in the image sensing unit shown in FIG. 4.

FIG. 8 is a cross-section view of another implementation of sensing devices included in the image sensing unit shown in FIG. 4.

FIG. 9 is a flowchart of an exemplary image sensing method according to an embodiment of the present invention.

FIG. 10 is a flowchart of an exemplary ambient light sensing (or color sensing) method according to an embodiment of the present invention.

FIG. 11 is a flowchart of an exemplary proximity sensing method according to an embodiment of the present invention.

FIG. 12 is a flowchart of an exemplary gesture detection method according to an embodiment of the present invention.

### DETAILED DESCRIPTION

In order to produce an more realistic image of an object, the proposed sensing apparatus detects respective infrared (IR) light signals reflected from the object when an IR light generating device is activated (i.e. emitting IR light) and deactivated (i.e. no IR light is emitted), and accordingly obtain corresponding sensing signals. Hence, interference from ambient light may be reduced/eliminated by processing the obtained sensing signals, thereby obtaining more accurate depth information and/or 3D image information of the object.

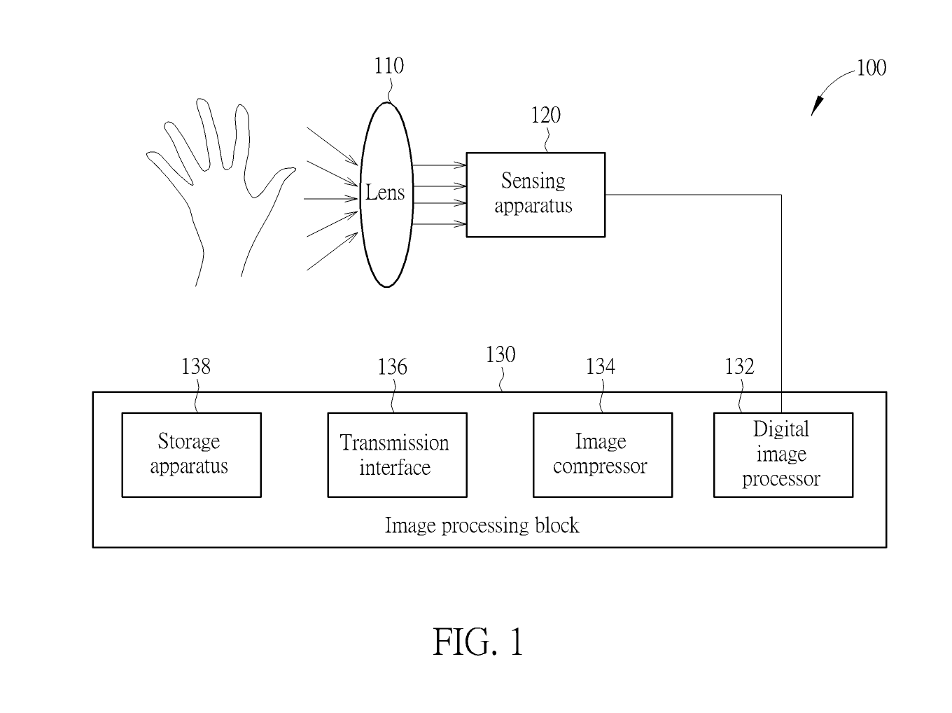

Please refer to FIG. 1, which is a block diagram illustrating an exemplary image processing system according to an embodiment of the present invention. As shown in FIG. 1, the image processing system 100 may include a lens 110, a sensing apparatus 120 and an image processing block 130. Consider a case where the image processing system 100 is operative to capture an image of a user's hand. The lens 110 may collect light reflected from the hand and direct the collected light to the sensing apparatus 120. Next, the sensing apparatus 120 may generate image information to the image processing block 130 according to received light signals. The image processing block 130 may include a digital image processor 132, an image compressor 134, a transmission interface 136 (e.g. a parallel interface or a serial interface) and a storage apparatus 138 (e.g. storing a complete image frame). As a person skilled in the art should understand image processing operations performed upon the generated image information by the digital image processor 132, the image compressor 134, the transmission interface 136 and the storage apparatus 138, further description of the image processing block 130 is omitted here for brevity.

Please note that the sensing apparatus 120 is an integrated sensing apparatus. Specifically, the sensing apparatus 120 may integrate multiple functions, including image sensing, ambient light sensing (including ambient color sensing and ambient color temperature sensing), proximity sensing, IR light emitting and/or gesture detection (recognition), into a single IC (or a single module). Furthermore, the sensing apparatus 120 may capture a 3D image of the user's hand so as to provide a more realistic output image. Further description is detailed below.

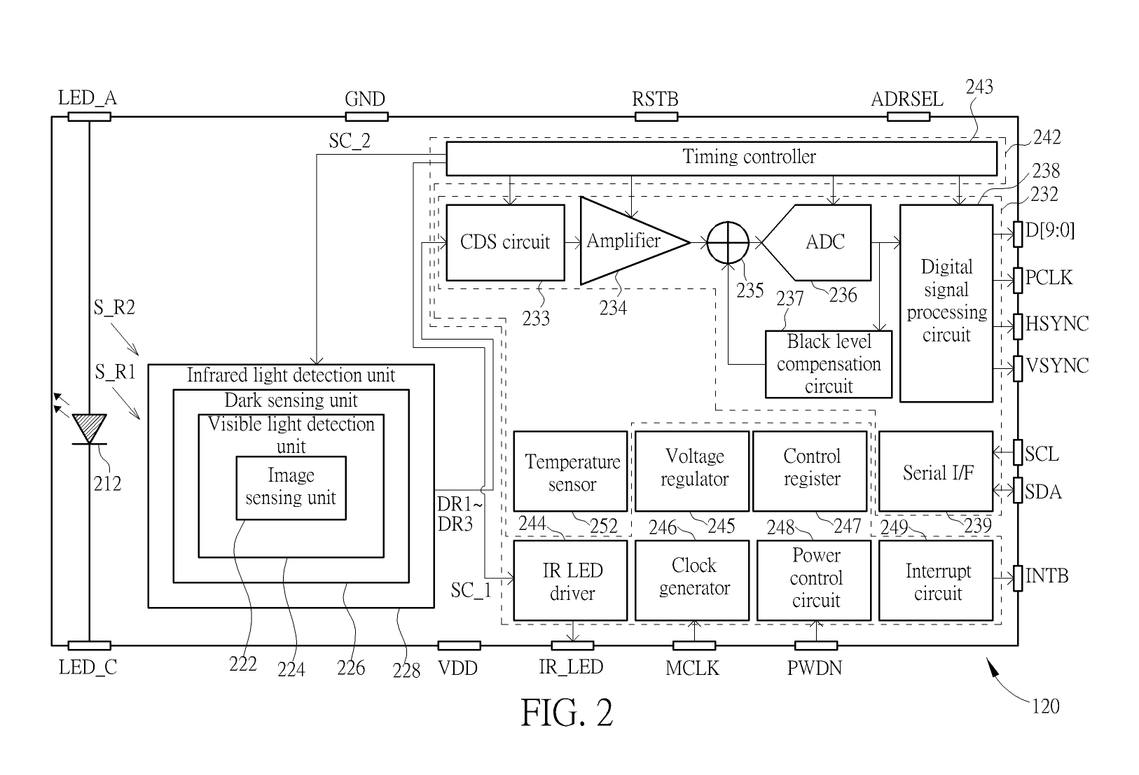

Please refer to FIG. 2, which is an implementation of the sensing apparatus 120 shown in FIG. 1. In this implementation, the sensing 120 may include, but is not limited to, an IR light generating device 212 (e.g. an infrared light-emitting diode (IR LED)), an image sensing unit 222, a visible light detection unit 224, a dark sensing unit 226, an IR light detection unit 228, a processing circuit 232, a control circuit 242 and a temperature sensor 252. A Pad VDD is coupled to a power source (not shown in FIG. 2). A pad GND is coupled to a ground voltage (not shown in FIG. 2). The IR light generating device 212 is coupled between a pad LED_A and a pad LED_C. A pad RSTB is used to receive a rest signal (not shown in FIG. 2). A pad ADRSEL is used to receive an address selection signal (not shown in FIG. 2).

The visible light detection unit 224 is disposed near a periphery of the image sensing 222, and is arranged to perform at least one of an ambient light sensing operation and a color sensing operation; The dark sensing unit 226 is disposed near the periphery of the image sensing unit 222, and is arranged for generating a reference signal (not shown in FIG. 2) for a dark/black level compensation; and the IR light detection unit 228 is disposed near the periphery of the image sensing unit 222, and is arranged to perform at least one of a proximity sensing operation, an object position detection and a gesture detection. In this embodiment, the dark sensing unit 226 is disposed outside the visible light detection unit 224, and the IR light detection unit 228 is disposed outside the dark sensing unit 226. This is for illustrative purposes only, and is not meant to be a limitation of the present invention. For example, the IR light detection unit 228 may be disposed between the visible light detection unit 224 and the dark sensing unit 226.

The control circuit 242 is coupled to the IR light generating device 212 (through a pad IR_LED), the image sensing unit 222, the visible light detection unit 224, the dark sensing unit 226, the IR light detection unit 228 and the processing circuit 232, wherein the image sensing unit 222 and the processing circuit 232 are coupled to each other. In addition, the control circuit 242 is used to control operations of the IR light generating device 212, the image sensing unit 222, the visible light detection unit 224, the dark sensing unit 226, the IR light detection unit 228 and the processing circuit 232. When the IR light generating device 212 is activated (i.e. emitting IR light), the image sensing unit 222 may detect a first IR light signal S_R1 reflected from an object (e.g. a user's hand shown in FIG. 1) and accordingly generate a first sensing signal DR1 (e.g. a photocurrent signal). As the received first IR light signal S_R1 is generated by the object due to reflection of IR light which is emitted by the IR light generating device 212, a distance between the IR light generating device 212 and the object may be determined according to energy of the first IR light signal S_R1. In other words, the first sensing signal DR1 generated by the image sensing unit 222 may include information associated with a distance between the object and the sensing apparatus 120.

However, the first sensing signal DR1 may further include information associated with background IR light (e.g. a reflected signal generated by the object due to reflection of the background IR light). Hence, the control circuit 242 may further deactivate the IR light generating device 212 (i.e. no IR light is emitted), and enable the image sensing unit 222 to detect a second IR light signal S_R2 (reflected from the object) in order to generate a second sensing signal DR2. The second sensing signal DR2 may be regarded as a detection result, which is obtained by detecting a reflected signal generated by the object due to reflection of the background IR light. Next, the processing circuit 232 may generate 3D image information of the object according to the first sensing signal DR1 and the second sensing signal DR2. For example, the 3D image information may include depth information, wherein the depth information may indicate a distance between the object and a reference point/plane (e.g. a distance between a point on a surface of the object and the sensing apparatus 120) or depth variations of the object (e.g. a 3D grayscale image of the object).

In one example, the processing circuit 232 may generate the depth information of the object according to a signal difference between the first sensing signal DR1 and the second sensing signal DR2. Specifically, the processing circuit 232 may perform subtraction upon the first sensing signal DR1 and the second sensing signal DR2 directly in order to eliminate/reduce interference from ambient light, thereby obtaining accurate depth information of the object. This is for illustrative purposes only, and is not meant to be a limitation of the present invention. In an alternative design, the processing circuit 232 may refer to the second sensing signal DR2 to adjust the first sensing signal DR1, and process the adjusted first sensing signal DR1 to generate the depth information.

The image sensing unit 222 may further detect a visible light signal S_VR reflected from the object to generate a third sensing signal DR3. Hence, the third sensing signal DR3 may include color information of the object. As the processing circuit 232 may generate the depth information of the object (e.g. the 3D grayscale image) according to the first sensing signal DR1 and the second sensing signal DR2, the processing circuit 232 may generate 3D image information of the object (i.e. color stereoscopic image information) according to the first sensing signal DR1, the second sensing signal DR2 and the third sensing signal DR3. Implementations of an image sensing unit capable of detecting IR light and visible light concurrently will be described later.

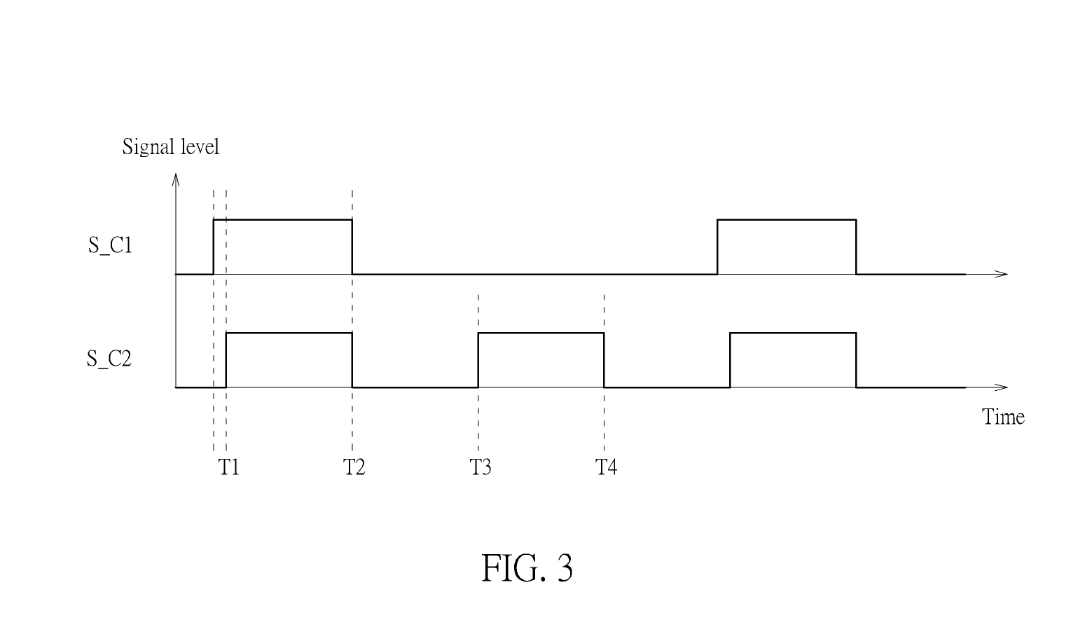

In one implementation, signal quality may be improved by controlling activation timings of the IR light generating device 212 and the image sensing unit 222. Please refer to FIG. 3 in conjunction with FIG. 2. FIG. 3 is a timing diagram of control signals of the IR light generating device 212 and the image sensing unit 222 shown in FIG. 2. In this implementation, the control circuit 242 may generate a plurality of control signals S_C1 and S_C2 to control activation/deactivation of the IR light generating device 212 and sensing operations of the image sensing unit 222, respectively. As shown in FIG. 3, after activating the IR light generating device 212, the control circuit 242 may enable the image sensing unit 222 to receive the first IR light signal S_R1 (e.g. a time point T1). After both the IR light generating device 212 and the image sensing unit 222 are enabled (e.g. after the first sensing signal DR1 is integrated over a predetermined period of time), the control circuit 242 may deactivate/disable the IR light generating device 212 and the image sensing unit 222 (i.e. a time point T2) simultaneously. In an alternative design, the control circuit 242 may activate/enable the IR light generating device 212 and the image sensing unit 222 simultaneously. In brief, when the image sensing unit 222 performs the sensing operation, the IR light generating device 212 may be activated (i.e. emitting IR light), thus ensuring that the received first IR light signal S_R1 corresponds mainly to IR light emitted by the IR light generating device 212.

When the IR light generating device 212 is deactivated, the control circuit 242 may enable the image sensing unit 222 to receive the second IR light signal S_R2 (e.g. a time point T3). After a predetermined period of time (e.g. an integration time of the second sensing signal DR2), the control circuit 242 may disable the image sensing unit 222 (i.e. a time point T4). In this implementation, when the IR light generating device 212 is deactivated, the control circuit 242 may further enable the image sensing unit 222 to detect the visible light signal S_VR reflected from the object in order to generate the third sensing signal DR3 (e.g. during a time period from the time point T3 to the time point T4). Hence, the image sensing unit 222 may complete depth information detection and color information detection concurrently.

Additionally, when disabling the image sensing unit 222 (i.e. the image sensing unit 222 is turned off), the control circuit 242 may enable the visible light detection unit 224 (i.e. the visible light detection unit 224 is turned on) to perform at least one of an ambient light sensing operation and a color sensing operation, thereby optimizing power consumption of the integrated sensing apparatus 120. Similarly, when disabling the image sensing unit 222, the control circuit 242 may enable the IR light detection unit 228 (i.e. the IR light detection unit 228 is turned on) to perform at least one of a proximity sensing operation, an object position detection and a gesture detection, thereby optimizing the power consumption of the integrated sensing apparatus 120.

In the implementation shown in FIG. 2, the control circuit 242 may include, but is not limited to, a timing controller 243, an IR LED driver 244, a voltage regulator 245, a clock generator 246, a control register 247, a power control circuit and an interrupt circuit 249. The timing controller 243 may be used to generate the control signal S_C1 to control the IR LED driver 244, and generate the control signal S_C2 to control the sensing unit 222. The IR LED driver 244 may be used to activate/deactivate the IR light generating device 212 according to the control signal S_C1. The clock generator 246 may receive an external clock (e.g. a master clock; not shown in FIG. 2) from a pad MCLK. The power control circuit 248 may receive a power control signal (not shown in FIG. 2) from a pad PWDN in order to control a power mode. The interrupt circuit 250 may receive an interrupt signal (not shown in FIG. 2) from a pad INTB. As a person skilled in the art should understand operations of each circuit element included in the control circuit 242, further description is omitted here for brevity.

The processing circuit 232 may include, but is not limited to, a correlated double sampling (CDS) circuit 233, an amplifier 234, an addition circuit 235, an analog-to-digital converter (ADC) 236, a dark/black level compensation circuit 237, a digital signal processing circuit 238 and a serial interface (serial I/F) 239 (e.g. a two wire inter-integrated circuit (I2C)). Signals outputted from the image sensing unit 222 (e.g. the first sensing signal DR1 and the second sensing signal DR2) may be processed by a CDS architecture with programmable gain settings, wherein the CDS architecture is composed of the CDS circuit 233 and the amplifier 234. The summing circuit 235 may sum an output of the amplifier 234 and an output of the black level compensation circuit 237 to produce an analog signal (i.e. an output of the summing circuit 235). Next, the ADC 236 may convert the analog signal to a digital signal (i.e. an output of the ADC 236), wherein the output of the black level compensation circuit 237 is generated according to the digital signal. The digital signal processing circuit 238 may perform further operations upon the digital signal (e.g. threshold comparison, hysteresis detection and other detection algorithm(s)), and pass resulting data to the image processing block 130 shown in FIG. 1 through a plurality of pads D [9:0], PCLK, HSYNC and VSYNC. The serial I/F 239 may be used for synchronous serial communication between chips, and is coupled to a pad SCL corresponding to a serial clock line (not shown in FIG. 2) and a pad SDA corresponding to a serial data line (not shown in FIG. 2). As a person skilled in the art should understand operations of each circuit element included in the processing circuit 232, further description is omitted here for brevity.

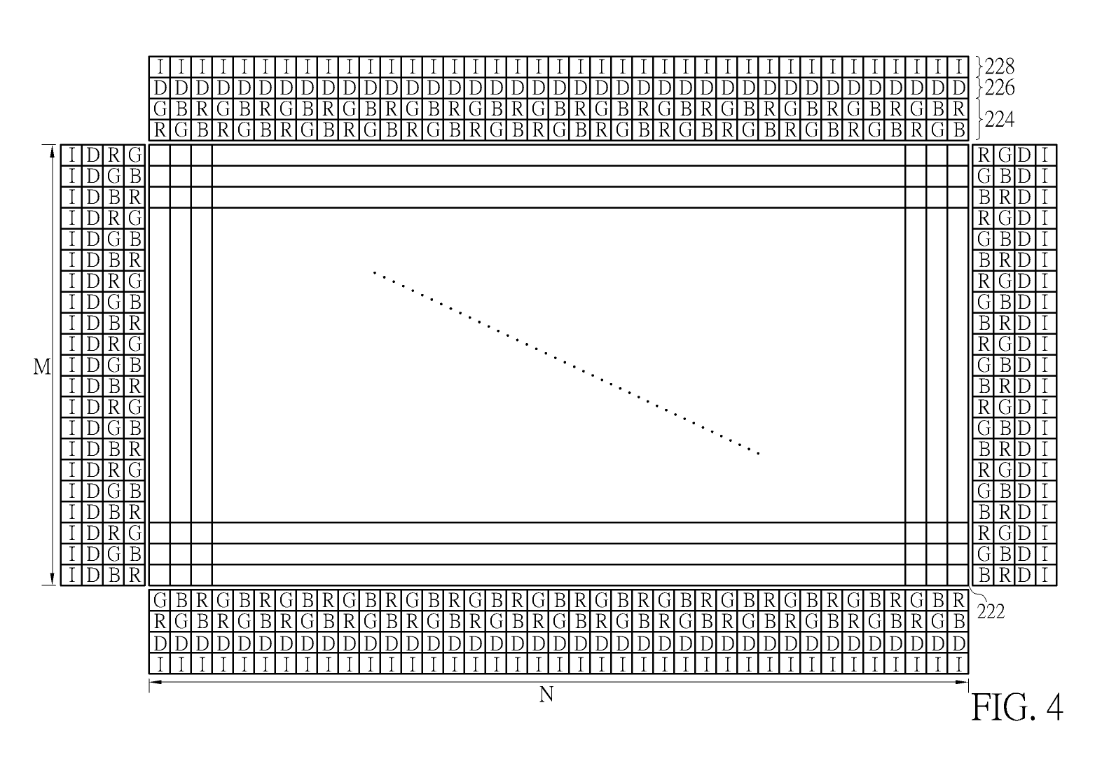

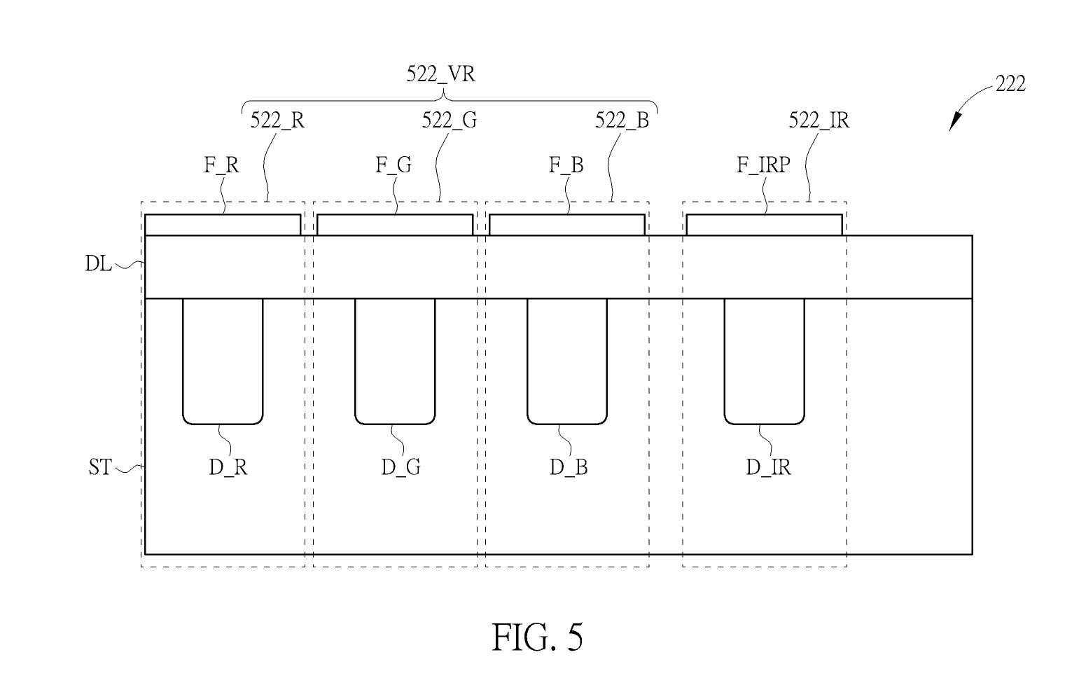

Please refer to FIG. 4 and FIG. 5 in conjunction with FIG. 2. FIG. 4 is an implementation of the image sensing unit 222, the visible light detection unit 224, the dark sensing unit 226 and the IR light detection unit 228 shown in FIG. 2. FIG. 5 is a cross-section view of sensing devices included in the image sensing unit 222 shown in FIG. 4. In this implementation, the image sensing unit 222 may be implemented by an M-row by N-column sensor array shown in FIG. 4 (e.g. an active pixel sensor (APS) array), wherein each of M and N is a positive integer. Additionally, as shown in FIG. 5, the image sensing unit 222 may include at least one IR light sensing device 522_IR and at least one visible light sensing device 522_VR. The IR light sensing device 522_IR is coupled to the processing circuit 232, and is arranged to detect the first IR light signal S_R1 and the second IR light signal S_R2 to generate the first sensing signal DR1 and the second sensing signal DR2, respectively; the visible light sensing device 522_VR is coupled to the processing circuit 232, and is arranged to detect the visible light signal S_VR to generate the third sensing signal DR3. In this implementation, the third sensing signal DR3 may include a red light converted signal, a green light converted signal and a blue light converted signal, which are generated respectively by a red light sensing device 522_R, a green light sensing device 522_G and a blue light sensing device 522_B included in the visible light sensing device 522_VR in response to detecting the visible light signal S_VR.

In practice, a plurality of photodetectors D_R, D_G, D_B and D_IR may be disposed on a substrate ST, a dielectric layer DL may be deposited on the photodetectors D_R, D_G, D_B and D_IR, and a red light filter F_R, a green light filter F_G, a blue light filter F_B and an IR pass filter F_IRP may be disposed/coated on the dielectric layer DL. Hence, the red light sensing device 522_R, the green light sensing device 522_G, the blue light sensing device 522_B and the IR light sensing device 522_IR may be implemented.

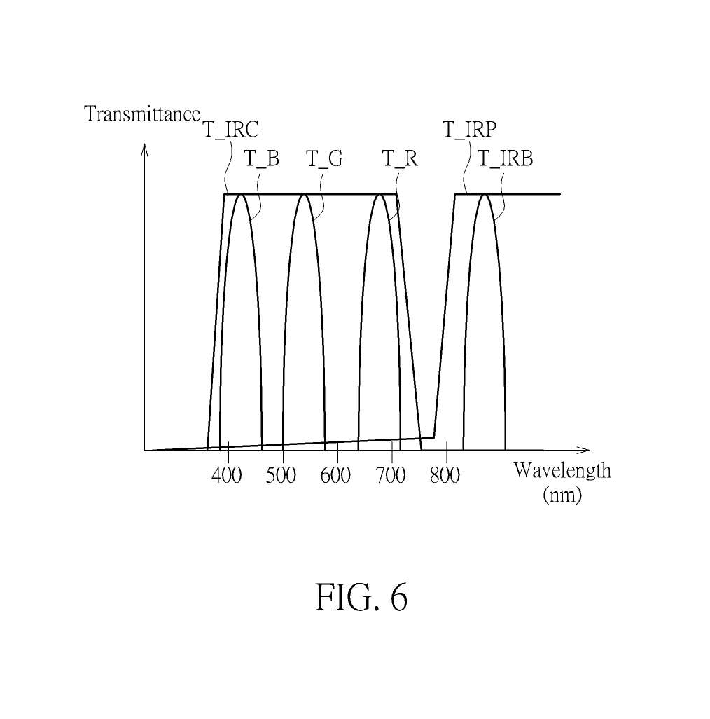

In this implementation, each filter may be implemented by, but is not limited to, a thin film filter. In addition, a relationship between a wavelength of incident light and a light transmittance of each filter is illustrated in FIG. 6. As shown in FIG. 6, visible light may be filtered by the red light filter F_R, the green light filter F_G and the blue light filter F_B to produce three wavebands, which correspond to transmittance curves T_R, T_G and T_B, respectively. IR light may be filtered by the IR pass filter F_IRP to produce a waveband corresponding to a transmittance curve T_IRP. Hence, when the image sensing unit 222 receives the visible light signal S_VR, the photodetector D_R may detect the visible light signal S_VR through the red light filter F_R to generate the red light converted signal (e.g. a current signal), the photodetector D_G may detect the visible light signal S_VR through the green light filter F_G to generate the green light converted signal, and the photodetector D_B may detect the visible light signal S_VR through the blue light filter F_B to generate the blue light converted signal. Furthermore, the photodetector D_IR may detect the first IR light signal S_R1 and the second IR light signal S_R2 through the IR pass filter F_IRP to generate corresponding IR light converted signals (i.e. the first sensing signal DR1 and the second sensing signal DR2), respectively. Next, the processing circuit 232 may generate the 3D color image information of the object according to the IR light converted signal, the red light converted signal, the green light converted signal and the blue light converted signal.

The above device architecture of the image sensing unit is for illustrative purposes only, and is not meant to be a limitation of the present invention. In an alternative design, the device architecture shown in FIG. 5 may further include a yellow light filter and a corresponding photodetector (not shown in FIG. 5) to increase the chroma. In an alternative design, the aforementioned red, green and blue light filters and the corresponding photodetectors may be replaced by a cyan light filter, a magenta light filter, a yellow light filter and a black light filter (i.e. process color) and corresponding photodetectors. In other words, as long as an image sensing unit may detect a visible light signal and an infrared light signal to generate 3D image information of an object, various modifications or changes may be made without departing from the scope and spirit of this invention.

As a person skilled in the art should understand that sub-pixels shown in FIG. 5 (e.g. the red light sensing device 522_R, the green light sensing device 522_G, the blue light sensing device 522_B and the IR light sensing device 522_IR) may be arranged in various manners (e.g. strip, delta or square arrangement) in the sensor array shown in FIG. 2, further description of sub-pixel arrangement is omitted here for brevity. In addition, the transmittance curves of the filters shown in FIG. 6 are for illustrative purposes only. For example, a transmittance curve corresponding to the IR pass filter F_IRP may be a bandpass transmittance curve T_IRB.

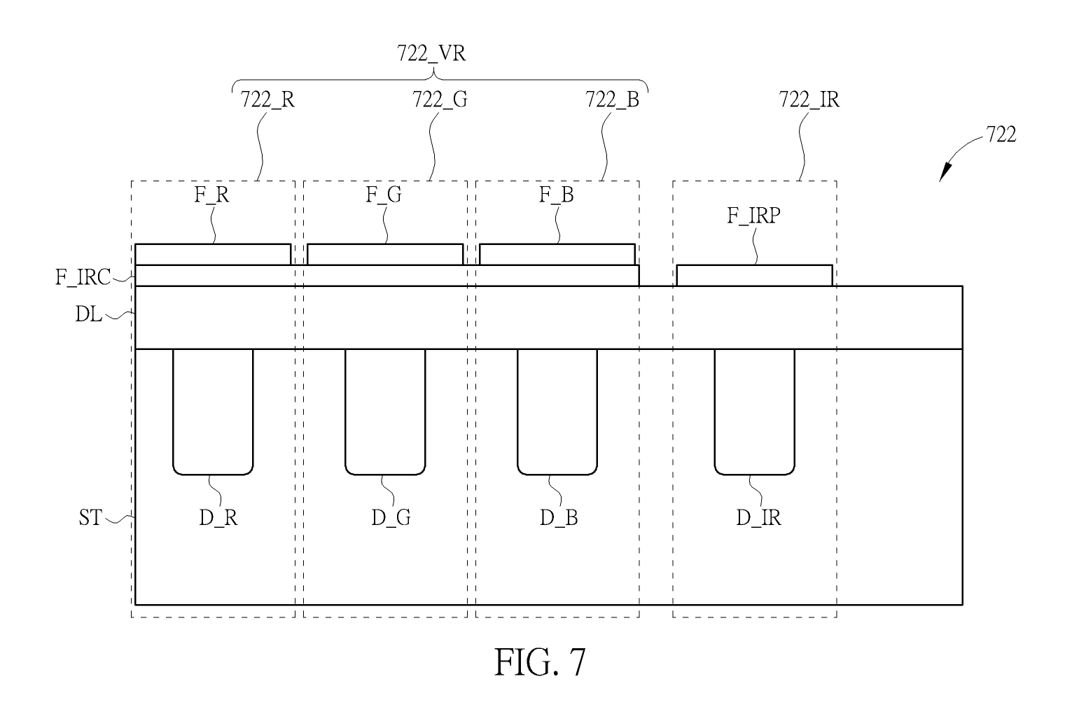

Please refer to FIG. 7, which is a cross-section view of another implementation of sensing devices included in the image sensing unit 222 shown in FIG. 4. The device architecture of the image sensing unit 722 is based on that of the image sensing unit 222 shown in FIG. 5, wherein the main difference therebetween is that the device architecture shown in FIG. 7 may further include an IR cut filter F_IRC. Specifically, the architecture of an IR light sensing device 722_IR included in the image sensing unit 722 is substantially the same as that of the IR light sensing device 522_IR shown in FIG. 5, while a visible light sensing device 722_VR may be an IR cut and visible light pass sensing device and include an IR cut and red light pass sensing device 722_R, an IR cut and green light pass sensing device 722_G and an IR cut and blue light pass sensing device 722_B. In contrast to the red light sensing device 522_R/the green light sensing device 522_G/the blue light sensing device 522_B, the IR cut and red light pass sensing device 722_R/the IR cut and green light pass sensing device 722_G/the IR cut and blue light pass sensing device 722_B may further include the IR cut filter F_IRC to filter out IR waveband signal(s), thereby improving signal quality of a converted signal (e.g. the aforementioned red/green/blue light converted signal) generated by the corresponding photodetector. The relationship between a wavelength of incident light and a light transmittance of the IR cut filter F_IRC is represented by a transmittance curve T_IRC shown in FIG. 6. As a person skilled in the art can readily understand the operation of the image sensing unit 722 and modifications thereof (e.g. other color filter (s) may be used) after reading the paragraphs directed to FIGS. 1-6, further description is omitted here for brevity.

In an alternative design, the image sensing unit 222 shown in FIG. 2 may include both of the device architecture of the visible light sensing device 522_VR shown in FIG. 5 and the device architecture of the visible light sensing device 722_VR shown in FIG. 7.

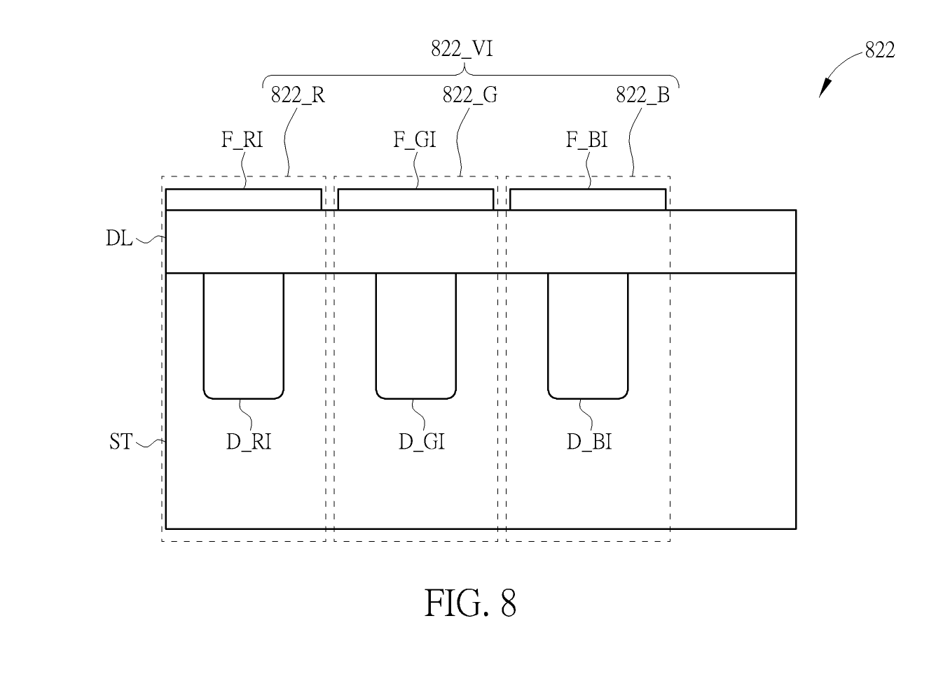

Please refer to FIG. 8 in conjunction with FIG. 2. FIG. 8 is a cross-section view of another implementation of sensing devices included in the image sensing unit 222 shown in FIG. 4. The device architecture of the image sensing unit 822 is based on that of the image sensing unit 222 shown in FIG. 5, wherein the main difference therebetween is that the device architecture shown in FIG. 8 may use dual-band bandpass filters. Specifically, the image sensing unit 822 may include at least one IR pass and visible light pass sensing device 822_VI, which is coupled the processing circuit 232 and is arranged to detect the first infrared light signal S_R1 and the second infrared light signal S_R2 to generate the first sensing signal DR1 and the second sensing signal DR2, respectively. Additionally, the IR pass and visible light pass sensing device 822_VI may further detect the visible light signal S_VR to generate the third sensing signal DR3. In this implementation, the third sensing signal DR3 may include a red light converted signal, a green light converted signal and a blue light converted signal, which are generated respectively by an IR pass and red light pass sensing device 822_R, an IR pass and green light pass sensing device 822_G and an IR pass and blue light pass sensing device 822_B included in the IR pass and visible light pass sensing device 822_VI in response to detecting the visible light signal S_VR. In addition, at least one of the IR pass and red light pass sensing device 822_R, the IR pass and green light pass sensing device 822_G and the IR pass and blue light pass sensing device 822_B further detects the first infrared light signal S_R1 and the second infrared light signal S_R2 to generate the first sensing signal DR1 and the second sensing signal DR2, respectively.

In practice, a plurality of photodetectors D_RI, D_GI and D_BI may be disposed on a substrate ST, a dielectric layer DL may be deposited on the photodetectors D_RI, D_GI and D_BI, and an IR pass and red light pass filter F_RI, an IR pass and green light pass filter F_GI and an IR pass and blue light pass filter F_BI may be disposed/coated on the dielectric layer DL. Hence, the IR pass and red light pass sensing device 822_R, the IR pass and green light pass sensing device 822_G and the IR pass and blue light pass sensing device 822_B may be implemented. In this implementation, a transmittance curve corresponding to the IR pass and red light pass filter F_RI may be a superposition of the transmittance curve T_R and the transmittance curve T_IRB shown in FIG. 6; a transmittance curve corresponding to the IR pass and green light pass filter F_GI may be a superposition of the transmittance curve T_R and the transmittance curve T_IRB shown in FIG. 6; and a transmittance curve corresponding to the IR pass and blue light pass filter F_BI may be a superposition of the transmittance curve T_B and the transmittance curve T_IRB shown in FIG. 6.

When the image sensing unit 822 receives the first infrared light signal S_R1, the second infrared light signal S_R2 the visible light signal S_VR, the photodetector D_RI may detect the visible light signal S_VR through the IR pass and red light pass filter F_RI to generate the red light converted signal (e.g. a current signal), the photodetector D_GI may detect the visible light signal S_VR through the IR pass and green light pass filter F_GI to generate the green light converted signal, and the photodetector D_BI may detect the visible light signal S_VR through the IR pass and blue light pass filter F_BI to generate the blue light converted signal. Furthermore, each photodetector may detect the first IR light signal S_R1 and the second IR light signal S_R2 through the corresponding dual-band bandpass filter to generate corresponding IR light converted signals (i.e. the first sensing signal DR1 and the second sensing signal DR2), respectively. Next, the processing circuit 232 may generate the 3D color image information of the object according to the IR light converted signal, the red light converted signal, the green light converted signal and the blue light converted signal.

Please refer to FIG. 4 in conjunction with FIG. 2. As shown in FIG. 4, the visible light detection unit 224 may include a plurality of pixels, wherein each pixel may include a red sub-pixel R, a green sub-pixel G and a blue sub-pixel B. In one implementation, the red sub-pixel R, the green sub-pixel G and the blue sub-pixel B may employ the architectures of the red light sensing device 522_R, the green light sensing device 522_G and the blue light sensing device 522_B, respectively. In another implementation, the red sub-pixel R, the green sub-pixel G and the blue sub-pixel B may employ the architectures of the IR cut and red light pass sensing device 722_R, the IR cut and green light pass sensing device 722_G and the IR cut and blue light pass sensing device 722_B, respectively. In still another implementation, in order to determine a coefficient of an illuminance (lux) calculation, the visible light detection unit 224 may include a first pixel having an IR cut filter (not shown in FIG. 4) and a second pixel with attenuated visible light sensitivity, wherein the first pixel may detect the visible light to obtain a first visible light sensing signal, and the second pixel may detect primary IR spectrum to obtain a second visible light sensing signal. The processing circuit 232 may determine the coefficient of the lux calculation according to a strength ratio between the first visible light sensing signal and the second visible light sensing signal. Additionally, the processing circuit may adjust image information (e.g. color brightness) according to a sensing result of the visible light detection unit 224.

The IR detection unit 228 may include a plurality of IR detectors (each labeled I). In a case where the IR detection unit 228 is used for proximity sensing, when the control circuit 242 activates the IR light generating device 212, the IR detectors are enabled, and the IR detection unit 228 may generate a first IR light sensing signal. When the control circuit 242 deactivates the IR light generating device 212, each IR detector is still in a turned-on state. Hence, the IR detection unit 228 may further generate a second IR light sensing signal, wherein a signal level difference between the first IR light sensing signal and the second IR light sensing signal may be outputted to the processing circuit 232 for the proximity sensing. In another case where the IR detection unit 228 is used for gesture recognition, when the control circuit 242 activates the IR light generating device 212, the IR detectors may be enabled alternately according to a specific activation sequence, wherein only a single IR detector is in the turned-on state in a period of time. For example, in a first period of time, the control circuit 242 may enable an IR detector, and further activate and deactivate the IR light generating device 212 sequentially. Hence, the IR detector may generate a first sensing signal and a second sensing signal to the processing circuit 232, and the processing circuit 232 may obtain a signal level difference between the first sensing signal and the second sensing signal. Ina second period of time, the control circuit 242 may enable another IR detector, and the processing circuit 232 may obtain another signal level difference, and so forth. The processing circuit 232 may receive sensing signals (signal level differences) of the IR detectors according to the specific activation sequence, thereby recognizing a gesture according to a relationship between a sensing signal intensity and time of each IR detector. Additionally, the processing circuit 232 may recognize a gesture according to a relationship between a sensing signal intensity and time of a single IR detector (i.e. determining whether an object is approaching or receding).

The dark sensing unit 226 may include a plurality of dark pixels (each labeled D). As sensing signals generated by the dark pixels are not generated in response to illumination, the sensing signals generated by the image sensing unit 222/the visible light detection unit 224/the IR light detection unit 228 may be subtracted by the sensing signals generated by the dark pixels, in order to compensate signal levels of the sensing signals generated by the image sensing unit 222/the visible light detection unit 224/the IR light detection unit 228.

In the embodiment shown in FIG. 4, each of the visible light detection unit 224, the dark sensing unit 226 and the IR light detection unit 228 may include a plurality of sensing devices (e.g. a plurality of pixels (each including a red, a green and a blue sub-pixel), a plurality of dark pixels and a plurality of IR detectors), wherein the sensing devices surround the image sensing unit 222 (i.e. the aforementioned sensor array) in order to obtain more complete image information corresponding to a field of view of the lens 110 shown in FIG. 1. Furthermore, as the visible light detection unit 224/the IR light detection unit 228 and the image sensing unit 222 may have similar (or the same) sensing device architectures, similar (or the same) fabrication processes may be employed to implement an sensing apparatus integrating multiple sensing functions, thus reducing production costs.

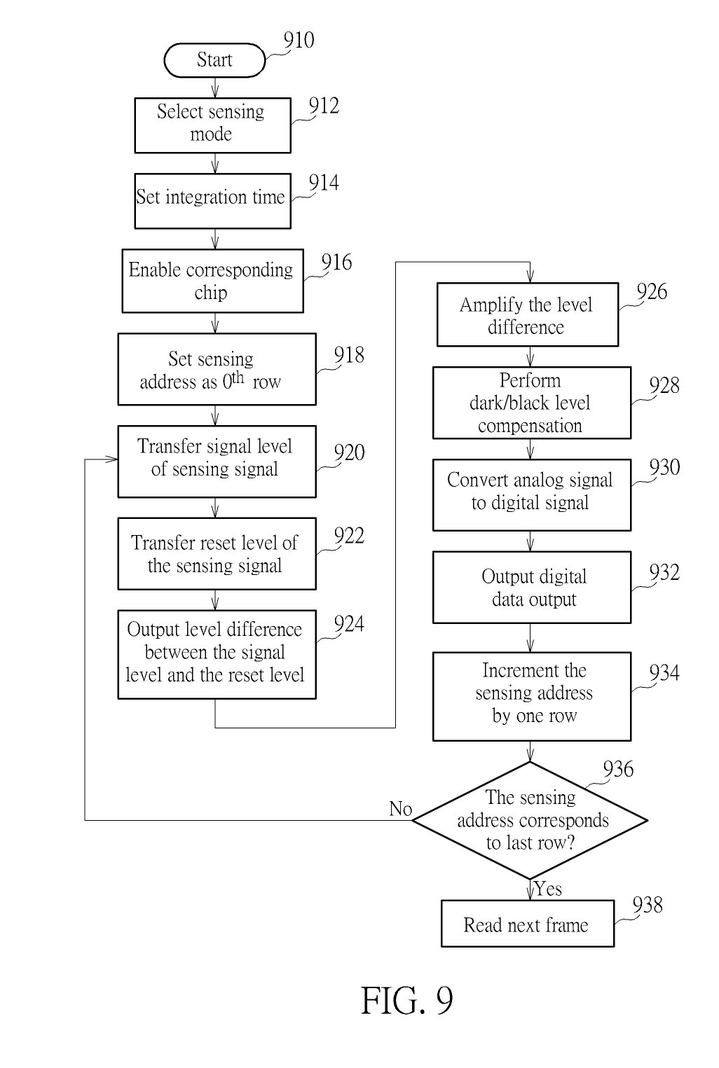

In addition, the image sensing unit 222, the visible light detection unit 224 and the IR light detection unit 228 may be enabled or disabled independently/individually. Methods for image sensing, ambient light sensing, proximity sensing and gesture detection are described below. Please refer to FIG. 9 in conjunction with FIG. 2. FIG. 9 is a flowchart of an exemplary image sensing method according to an embodiment of the present invention. For illustrative purposes, the following describes image sensing operation upon a single frame. The exemplary image sensing method may be summarized below.

Step 900: Start.

Step 912: Select a sensing mode of the sensing apparatus 120 (e.g. an image sensing mode, an ambient light sensing mode, a proximity sensing mode, a gesture detection mode or a temperature sensing mode). In this embodiment, the image sensing mode is selected.

Step 914: Set sensing signal integration time.

Step 916: Enable a corresponding chip (i.e. the sensing apparatus 120 or a chip including the sensing apparatus 120).

Step 918: Set sensing address of the image sensing unit 222 as a 0^{th} row.

Step 920: Transfer a signal level of a sensing signal of the image sensing unit 222 to the CDS circuit 233.

Step 922: Reset the sensing signal in order to transfer a reset level of the sensing signal to the CDS circuit 233.

Step 924: Output a level difference between the signal level and the reset level to the amplifier 234.

Step 926: Amplify the level difference.

Step 928: Use the dark/black level compensation circuit 237 to perform dark/black level compensation.

Step 930: Use the ADC 236 to convert an analog signal generated by the summing circuit 235 to a digital signal.

Step 932: Use the digital signal processing circuit 238 to process the digital signal, and accordingly output a digital data output.

Step 934: Increment the sensing address of the image sensing unit 222 by one row.

Step 936: Determine whether the sensing address of the image sensing unit 222 corresponds to a last row. If yes, go to step 938; otherwise, return to step 920.

Step 938: Read a next frame.

In step 920, the sensing signal integration time may be adjusted based on sensitivity of a sensing device in order to obtain a better sensing result. As a person skilled in the art should readily understand the operation of each step shown in FIG. 9 after reading the description directed to FIGS. 1-8, further description is omitted here for brevity.

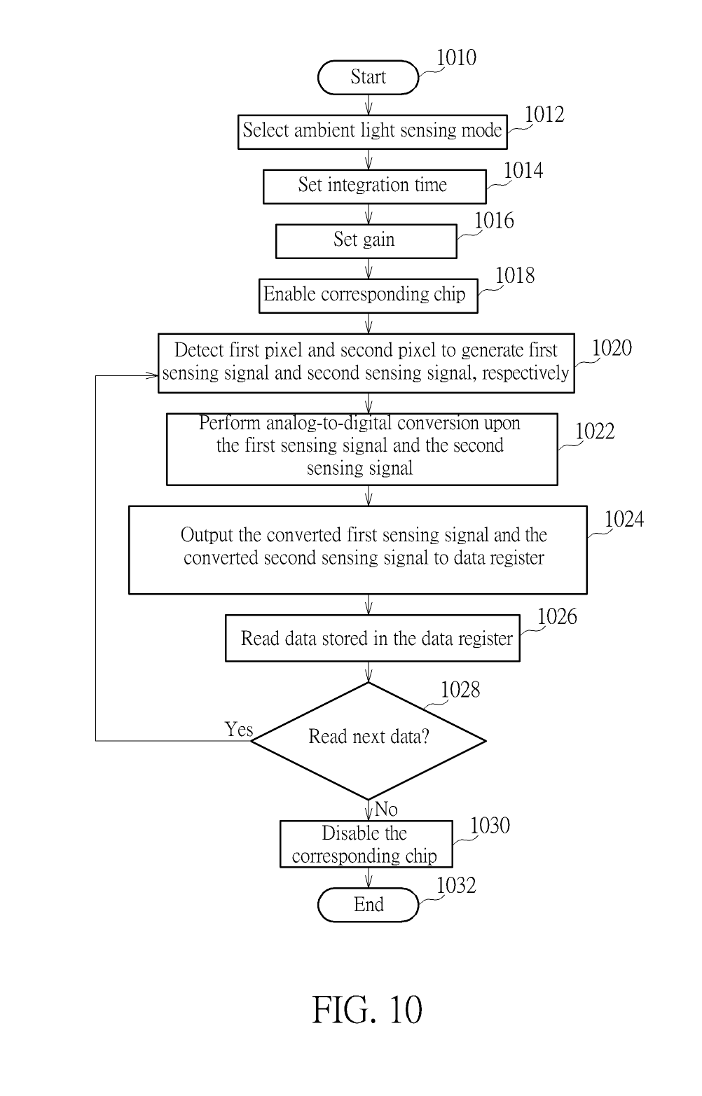

Please refer to FIG. 10, which is a flowchart of an exemplary ambient light sensing (or color sensing) method according to an embodiment of the present invention. The exemplary ambient light sensing method may be summarized below.

Step 1000: Start.

Step 1012: Select an ambient light sensing mode.

Step 1014: Set sensing signal integration time.

Step 1016: Set a gain of an amplifier (e.g. the amplifier 234 shown in FIG. 2).

Step 1018: Enable a corresponding chip.

Step 1020: Detect a first pixel (e.g. a pixel including a red, a green and a blue sub-pixel shown in FIG. 4) and a second pixel (e.g. another pixel including a red, a green and a blue sub-pixel shown in FIG. 4) to generate a first sensing signal and a second sensing signal, respectively.

Step 1022: Perform analog-to-digital conversion upon the first sensing signal and the second sensing signal.

Step 1024: Output the converted first sensing signal and the converted second sensing signal to a data register.

Step 1026: Read data stored in the data register.

Step 1028: Determine whether to read next data? If yes, return to step 1020; otherwise, go to step 1030.

Step 1030: Disable the corresponding chip.

Step 1032: End.

In step 1026, a coefficient of lux calculation may be determined according to a strength ratio between the converted first sensing signal and the converted second sensing signal. In step 1028, if the ambient light sensing operation continues, the flow may return to step 1020 to read the next data. As a person skilled in the art should readily understand the operation of each step shown in FIG. 10 after reading the description directed to FIGS. 1-9, further description is omitted here for brevity.

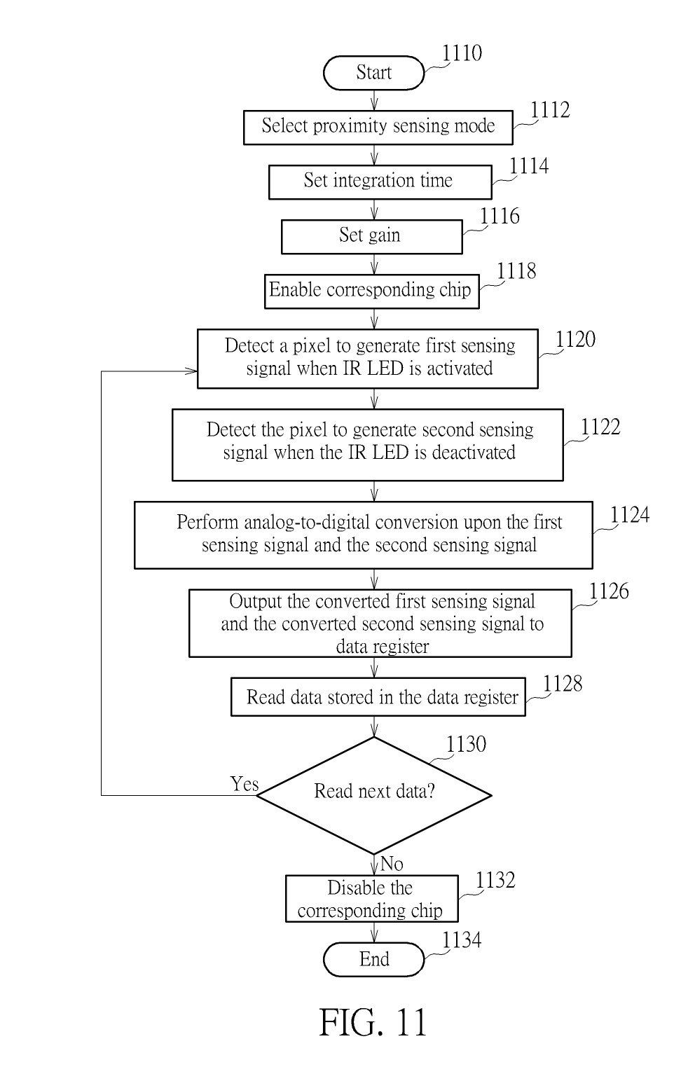

Please refer to FIG. 11, which is a flowchart of an exemplary proximity sensing method according to an embodiment of the present invention. The exemplary proximity sensing method may be summarized below.

Step 1100: Start.

Step 1112: Select a proximity sensing mode.

Step 1114: Set sensing signal integration time.

Step 1116: Set a gain of an amplifier (e.g. the amplifier 234 shown in FIG. 2).

Step 1118: Enable a corresponding chip.

Step 1120: Detect a pixel (e.g. a pixel labeled I shown in FIG. 4) to generate a first sensing signal when an IR LED is activated.

Step 1122: Detect the pixel to generate a second sensing signal when the IR LED is deactivated.

Step 1124: Perform analog-to-digital conversion upon the first sensing signal and the second sensing signal.

Step 1126: Output the converted first sensing signal and the converted second sensing signal to a data register.

Step 1128: Read data stored in the data register.

Step 1130: Determine whether to read next data? If yes, return to step 1120; otherwise, go to step 1132.

Step 1132: Disable the corresponding chip.

Step 1134: End.

In step 1128, a distance between an object and an sensing apparatus may be determined according to a signal level difference between the converted first sensing signal and the converted second sensing signal. As a person skilled in the art should readily understand the operation of each step shown in FIG. 11 after reading the description directed to FIGS. 1-10, further description is omitted here for brevity.

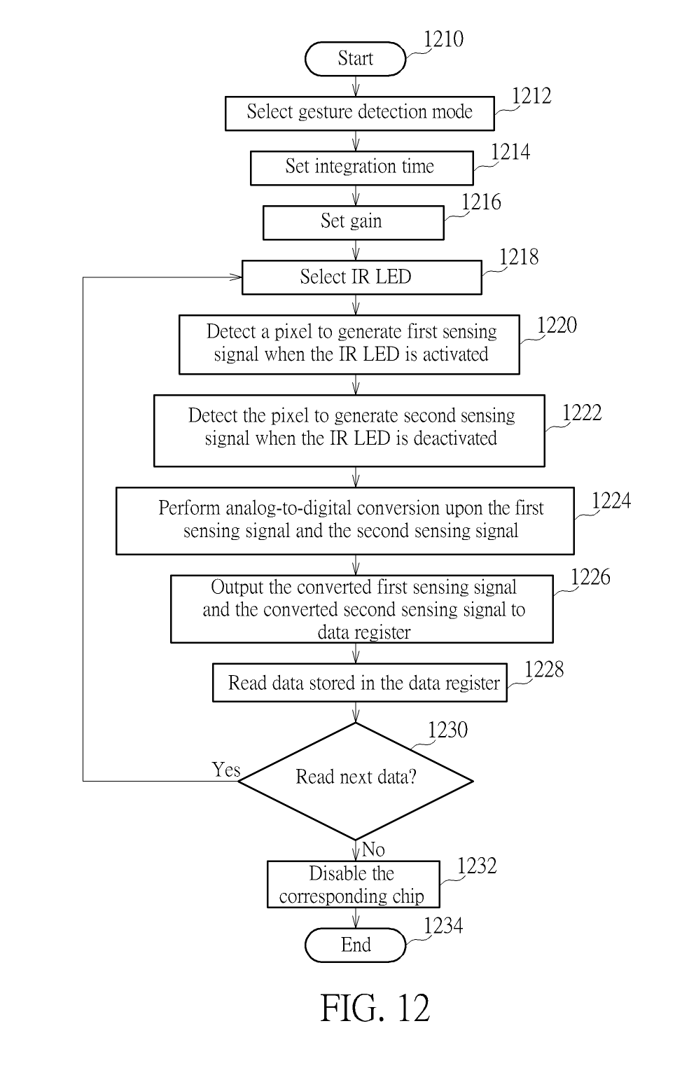

Please refer to FIG. 12, which is a flowchart of an exemplary gesture detection method according to an embodiment of the present invention. The exemplary gesture detection method may be summarized below.

Step 1200: Start.

Step 1212: Select a gesture detection mode.

Step 1214: Set sensing signal integration time.

Step 1216: Set a gain of an amplifier (e.g. the amplifier 234 shown in FIG. 2).

Step 1218: Select an IR LED.

Step 1220: Detect a pixel (e.g. a pixel labeled I shown in FIG. 4) to generate a first sensing signal when the IR LED is activated.

Step 1222: Detect the pixel to generate a second sensing signal when the IR LED is deactivated.

Step 1224: Perform analog-to-digital conversion upon the first sensing signal and the second sensing signal.

Step 1226: Output the converted first sensing signal and the converted second sensing signal to a data register.

Step 1228: Read data stored in the data register.

Step 1230: Determine whether to read next data? If yes, return to step 1218; otherwise, go to step 1232.

Step 1232: Disable the corresponding chip.

Step 1234: End.

In step 1228, a gesture may be recognized according to a relationship between a sensing signal intensity and time of a single pixel (i.e. the pixel). In an alternative design, an object position (or a user's gesture) may be recognized according respective relationships (sensing signal intensity versus time) of a plurality of pixels. As a person skilled in the art should readily understand the operation of each step shown in FIG. 12 after reading the description directed to FIGS. 1-11, further description is omitted here for brevity.

Please note that, as the image sensing unit 222 includes the device architecture of IR detector (proximity sensor) (e.g. the IR light sensing device 522_IR), the sensing apparatus 120 shown in FIG. 2 may determine a position and/or a corresponding gesture of an object. In other words, the processing circuit 232 may further recognize the gesture corresponding to the object according to a relationship between the obtained depth information and time. For example, if the obtained depth information indicates that a distance between the object and the sensing apparatus 120 decreases, it is determined that the user performs an approaching gesture upon the sensing apparatus 120. Additionally, as the image sensing unit 222 shown in FIG. 4 may detect an image of the object, the sensing apparatus 120 shown in FIG. 2 may determine the position and/or the corresponding gesture of the object directly according to the obtained 3D image information. In one implementation, a plurality of proximity sensors may be embedded in the red, green, and blue (RGB) image sensor array shown in FIG. 4 in order to realize an integrated sensing apparatus with multiple functions. Furthermore, the image sensing unit 222 shown in FIG. 2 may obtain 3D image information (e.g. a 3D grayscale image) by means of the proximity sensors only, and recognize the position and the corresponding gesture of the object. In other words, the sensor array shown in FIG. 4 may include the device architecture of the proximity sensor only.

In view of the above, the proposed image processing system may integrate an image sensor, a PS and an ALS, and use cross-function sensor(s) (e.g. a PS for image sensing and gesture recognition, and an ALS for ambient light sensing and color sensing) to enhance system performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing apparatus, comprising:
an infrared light generating device;
an image sensing unit, for detecting a first infrared light signal reflected from an object to generate a first sensing signal when the infrared light generating device is activated, and detecting a second infrared light signal reflected from the object to generate a second sensing signal when the infrared light generating device is deactivated;
a processing circuit, coupled to the image sensing unit, the processing circuit arranged for generating three-dimensional image information of the object according to at least the first sensing signal and the second sensing signal, wherein the three-dimensional image information includes depth information; and
a control circuit, coupled to the infrared light generating device, the image sensing unit and the processing circuit, the control circuit arranged for control activation and deactivation of the infrared light generating device, sensing operations of the image sensing unit, and signal processing operations of the processing circuit.

2. The sensing apparatus of claim 1, wherein the processing circuit generates the depth information of the object according to a signal difference between the first sensing signal and the second sensing signal.

3. The sensing apparatus of claim 1, wherein the image sensing unit further detects a visible light signal reflected from the object to generate a third sensing signal, and the processing circuit generates the three-dimensional image information of the object according to the first sensing signal, the second sensing signal and the third sensing signal.

4. The sensing apparatus of claim 3, wherein the image sensing unit detects the visible light signal reflected from the object to generate a third sensing signal when the infrared light generating device is deactivated.

5. The sensing apparatus of claim 3, wherein the image sensing unit comprises:
at least one infrared light sensing device, coupled to the processing circuit, the at least one infrared light sensing device arranged for detecting the first infrared light signal and the second infrared light signal to generate the first sensing signal and the second sensing signal, respectively; and
at least one visible light sensing device, coupled to the processing circuit, the at least one visible light sensing device arranged for detecting the visible light signal to generate the third sensing signal.

6. The sensing apparatus of claim 5, wherein the third sensing signal comprises a red light converted signal, a green light converted signal and a blue light converted signal, and the at least one visible light sensing device comprises:
a red light sensing device, coupled to the processing circuit, the red light sensing device arranged for detecting the visible light signal to generate the red light converted signal;
a green light sensing device, coupled to the processing circuit, the green light sensing device arranged for detecting the visible light signal to generate the green light converted signal; and
a blue light sensing device, coupled to the processing circuit, the blue light sensing device arranged for detecting the visible light signal to generate the blue light converted signal.

7. The sensing apparatus of claim 5, wherein the at least one visible light sensing device comprises at least one infrared cut and visible light pass sensing device.

8. The sensing apparatus of claim 7, wherein the third sensing signal comprises a red light converted signal, a green light converted signal and a blue light converted signal, and the at least one infrared cut and visible pass sensing device comprises:
an infrared cut and red light pass sensing device, coupled to the processing circuit, the infrared cut and red light pass sensing device arranged for detecting the visible light signal to generate the red light converted signal;
an infrared cut and green light pass sensing device, coupled to the processing circuit, the infrared cut and green light pass sensing device arranged for detecting the visible light signal to generate the green light converted signal; and
an infrared cut and blue light pass sensing device, coupled to the processing circuit, the infrared cut and blue light pass sensing device arranged for detecting the visible light signal to generate the blue light converted signal.

9. The sensing apparatus of claim 3, wherein the image sensing unit comprises:
at least one infrared pass and visible light pass sensing device, coupled to the processing circuit, the least one infrared pass and visible light pass sensing device arranged for detecting the first infrared light signal and the second infrared light signal to generate the first sensing signal and the second sensing signal, respectively, and detecting the visible light signal to generate the third sensing signal.

10. The sensing apparatus of claim 9, wherein the third sensing signal comprises a red light converted signal, a green light converted signal and a blue light converted signal, and the at least one infrared pass and visible light pass sensing device comprises:
an infrared pass and red light pass sensing device, coupled to the processing circuit, the infrared pass and red light pass sensing device arranged for detecting the visible light signal to generate the red light converted signal;
an infrared pass and green light pass sensing device, coupled to the processing circuit, the infrared pass and green light pass sensing device arranged for detecting the visible light signal to generate the green light converted signal; and
an infrared pass and blue light pass sensing device, coupled to the processing circuit, the infrared pass and blue light pass sensing device arranged for detecting the visible light signal to generate the blue light converted signal;
wherein at least one of the infrared pass and red light pass sensing device, the infrared pass and green light pass sensing device and the infrared pass and blue light pass sensing device further detects the first infrared light signal and the second infrared light signal to generate the first sensing signal and the second sensing signal, respectively.

11. The sensing apparatus of claim 1, wherein the processing circuit further recognizes an approaching gesture and a receding gesture according to a relationship between time and the depth information.

12. The sensing apparatus of claim 1, further comprising:
an infrared light detection unit, disposed near a periphery of the image sensing unit and controlled by the control circuit to perform at least one of a proximity sensing operation, an object position detection and a gesture detection, wherein at least one of the proximity sensing operation, the object position detection and the gesture detection is performed in a period during which the control circuit disables the image sensing unit.

13. The sensing apparatus of claim 1, further comprising:
a visible light detection unit, disposed near a periphery of the image sensing unit and controlled by the control circuit to perform at least one of an ambient light sensing operation and a color sensing operation, wherein at least one of the ambient light sensing operation and the color sensing operation is performed in a period during which the control circuit disables the image sensing unit.

14. The sensing apparatus of claim 1, further comprising:
a dark sensing unit, disposed at a periphery of the image sensing unit and controlled by the control circuit, the dark sensing unit arranged for generating a reference signal for a dark level compensation.

15. A sensing method, comprising:
activating an infrared light generating device to detect a first infrared light signal reflected from an object in order to generate a first sensing signal;
deactivating the infrared light generating device to detect a second infrared light signal reflected from the object in order to generate a second sensing signal; and
generating three-dimensional image information of the object according to at least a signal difference between the first sensing signal and the second sensing signal, wherein the three-dimensional image information includes depth information.

16. The sensing method of claim 15, further comprising:
detecting a visible light signal reflected from the object to generate a third sensing signal; and
the step of generating the three-dimensional image information of the object according to at least the signal difference between the first sensing signal and the second sensing signal comprises:
generating the three-dimensional image information of the object according to the first sensing signal, the second sensing signal and the third sensing signal.

17. The sensing method of claim 16, wherein the step of detecting the visible light signal reflected from the object to generate the third sensing signal is performed in a period during which the infrared light generating device is deactivated.

18. The sensing method of claim 15, further comprising:
recognizing an approaching gesture and a receding gesture according to a relationship between time and the depth information.
